(19) United States
(12) Patent Application Publication
(10) Pub. No.: US 2015/0101157 A1
(43) Pub. Date: Apr. 16, 2015

(54) SCREW CLAMP HAVING MOVABLE FOLLOWER

(71) Applicant: Oxti Corporation, Taipei (TW)

(72) Inventor: Chih Feng HO, Taipei (TW)

(73) Assignee: Oxti Corporation, Taipei (TW)

(21) Appl. No.: 14/051,561

(22) Filed: Oct. 11, 2013

(51) Int. Cl. B25B 5/10; B25B 5/16; B25B 5/02

(52) U.S. Cl. CPC B25B 5/10; B25B 5/02; B25B 5/166
USPC 24/486

(57) ABSTRACT

A screw clamp includes a carrier member having a through hole and a compartment communicating with each other, a clamping device includes a follower slidably engaged in the compartment of the carrier member and an anchoring board disposed below the follower which includes a screw hole aligned with the through hole of the carrier member, and a screw is engaged through the through hole of the carrier member and engaged with the screw hole of the follower for moving the follower up and down relative to the carrier member when the screw is rotated relative to the carrier member and for moving anchoring board up and down to engage with a table surface.

### BACKGROUND OF THE INVENTION

1. Field of the Invention

The present invention relates to a screw clamp or carrier or support device, and more particularly to a screw clamp or carrier or support device including an improved structure arranged for allowing the screw clamp or carrier or support device to be easily actuated or operated by the user, and including an anchoring board attachable to a carrier member for allowing the carrier member to be easily and quickly engaged through a tiny space beside an edge portion of a table plate.

2. Description of the Prior Art

Typical screw clamps comprise a C-shaped clamp body, and a bolt or screw threaded and attached or mounted to one end of the clamp body and rotatable and movable or adjustable toward the other end of the clamp body for attaching or mounting or securing or clamping the clamp body onto various supporting members or tables.

For example, U.S. Pat. No. 4,494,177 to Matthews, U.S. Pat. No. 4,569,498 to Ermanski, U.S. Pat. No. 4,582,307 to Wang, U.S. Pat. No. 4,627,604 to Choi, U.S. Pat. No. 4,736,878 to Rasor, U.S. Pat. No. 4,874,155 to Goul, U.S. Pat. No. 4,921,234 to Peterson, U.S. Pat. No. 5,180,220 to Van Kalsbeek, U.S. Pat. No. 5,370,570 to Harris, U.S. Pat. No. 5,423,525 to Spainhower, U.S. Pat. No. 5,765,902 to Love, U.S. Pat. No. 5,833,180 to Baranowski, U.S. Pat. No. 5,833,189 to Rossman et al., U.S. Pat. No. 6,032,939 to Chen, U.S. Pat. No. 6,086,228 to McGowan et al., U.S. Pat. No. 6,375,140 to Shen, U.S. Pat. No. 6,394,403 to Hung, U.S. Pat. No. 6,478,275 to Huang, U.S. Pat. No. 7,104,673 to Yu, and U.S. Pat. No. 7,121,516 to Koh disclose several of the typical screw clamps, clamp bases or the like each also comprising a bolt or screw threaded and attached or mounted to one end of the clamp body for clamping onto various supporting members or tables and for supporting the other members or objects, such as the keyboards, the monitors or the like.

However, the clamp body includes a solid and spatial structure that may not be folded to the compact folding structure and that may not be easily and quickly attached or mounted or secured or clamped onto various supporting members or tables. The users have to bend or squat lower than the supporting members or tables for actuating or operating or rotating or driving the screw or bolt to attach the clamp body onto the supporting members or tables.

The present invention has arisen to mitigate and/or obviate the afore-described disadvantages of the conventional screw clamps or carriers or support devices.

### SUMMARY OF THE INVENTION

The primary objective of the present invention is to provide a screw clamp including an improved structure arranged for allowing the screw clamp or carrier or support device to be easily actuated or operated by the user.

The other objective of the present invention is to provide a screw clamp including an anchoring board attachable to a carrier member for allowing the carrier member to be easily and quickly and readily engaged through a tiny space beside an edge portion of a table plate.

In accordance with one aspect of the invention, there is provided a screw clamp for attaching to a table plate, comprising a carrier member to be supported on the table plate, the carrier member including a compartment formed therein, and including a through hole formed in the carrier member and communicating with the compartment of the carrier member, and including an attachment mechanism for attaching a facility, a clamping device including a follower slidably received and engaged in the compartment of the carrier member, and including an anchoring board provided below the follower for engaging with a bottom surface of the table plate, the follower including a screw hole formed therein and aligned with the through hole of the carrier member, and a screw engaged through the through hole of the carrier member and engaged with the screw hole of the follower for moving the follower up and down relative to the carrier member when the screw is rotated relative to the carrier member.

The follower includes an orifice formed therein, and a guiding member is attached to the carrier member and slidably received and engaged in the orifice of the follower for guiding and limiting the follower to slide up and down relative to the carrier member. The carrier member includes a screw hole formed therein and communicating with the compartment of the carrier member, and the guiding member includes a threaded segment for engaging with the screw hole of the carrier member.

The carrier member includes a retaining member attached to the screw and located below the follower for limiting the follower to move relative to the screw and for preventing the follower from being disengaged from the screw. The carrier member includes a retaining member attached to the screw and located above the follower for limiting the follower to move relative to the screw.

The compartment of the carrier member includes a non-circular cross section and opened downwardly and rearwardly, and the follower includes a non-circular cross section for being guided and limited to slide up and down relative to the compartment of the carrier member and for preventing the follower from being rotated relative to the carrier member.

The clamping device includes a guide member attached to the follower, and the anchoring board is slidably attached to the guide member. The follower includes an extension extended downwardly therefrom and perpendicular to the follower and located outside the compartment of the carrier member for attaching the guide member.

The guide member includes two side columns each having a channel, the anchoring board includes two spaced ears slidably received and engaged in the channels of the columns respectively for guiding and limiting the anchoring board to slide up and down relative to the guide member. The columns each include a C-shaped cross section having a rear panel and a front panel which is parallel to the rear panel and shorter than the rear panel.

The clamping device includes two fasteners engaged through the rear panels of the columns and engaged with the front panels of the columns. The columns each include a notch formed in the front panel for engaging with the fastener.

The guide member includes a platform, and includes a longitudinal slot formed in the platform, and a fastener engaged through the anchoring board and engaged through the slot of the platform. The guide member includes a passage formed therein and defined by the platform, and a locking member is slidably received and engaged in the passage of the guide member and includes a screw hole for engaging with the fastener.

The locking member includes at least one key extended therefrom and slidably engaged in the longitudinal slot of the platform for preventing the locking member from being rotated relative to the guide member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a screw clamp in accordance with the present invention;

FIG. 2 is a perspective view of the screw clamp;

FIG. 3 is a side plan schematic view of the screw clamp;

FIG. 4 is another side plan schematic view similar to FIG. 3, illustrating the operation of the screw clamp;

FIG. 5 is another exploded view similar to FIG. 1, illustrating the other arrangement of the screw clamp;

FIG. 6 is a perspective view of the screw clamp as shown in FIG. 5; and

FIG. 7 is a side plan schematic view illustrating the operation of the screw clamp as shown in FIGS. 5-6.

### DETAILED DESCRIPTION OF THE PREFERRED EMBODIMENT

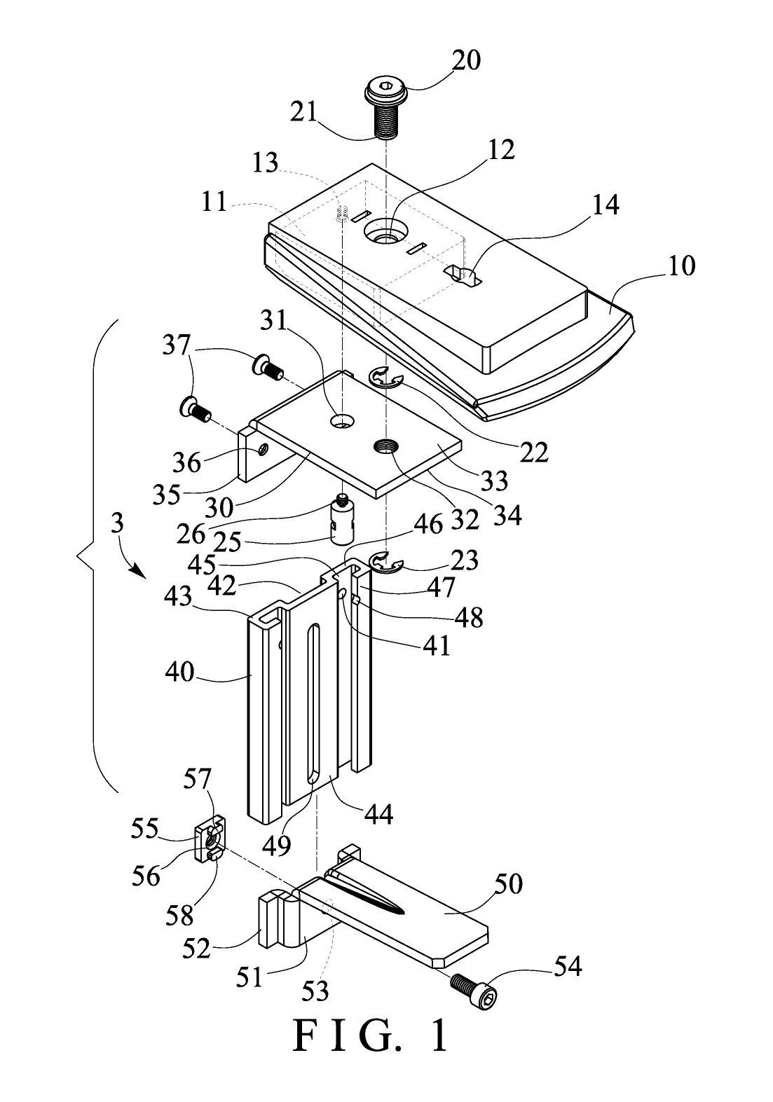

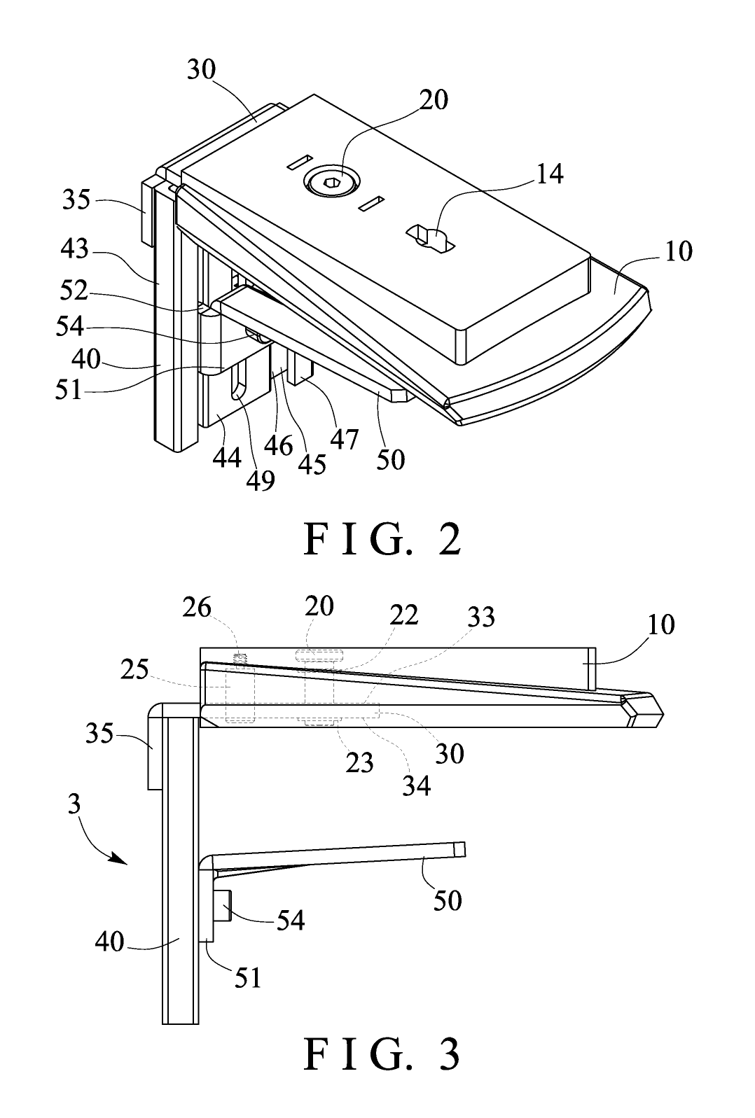

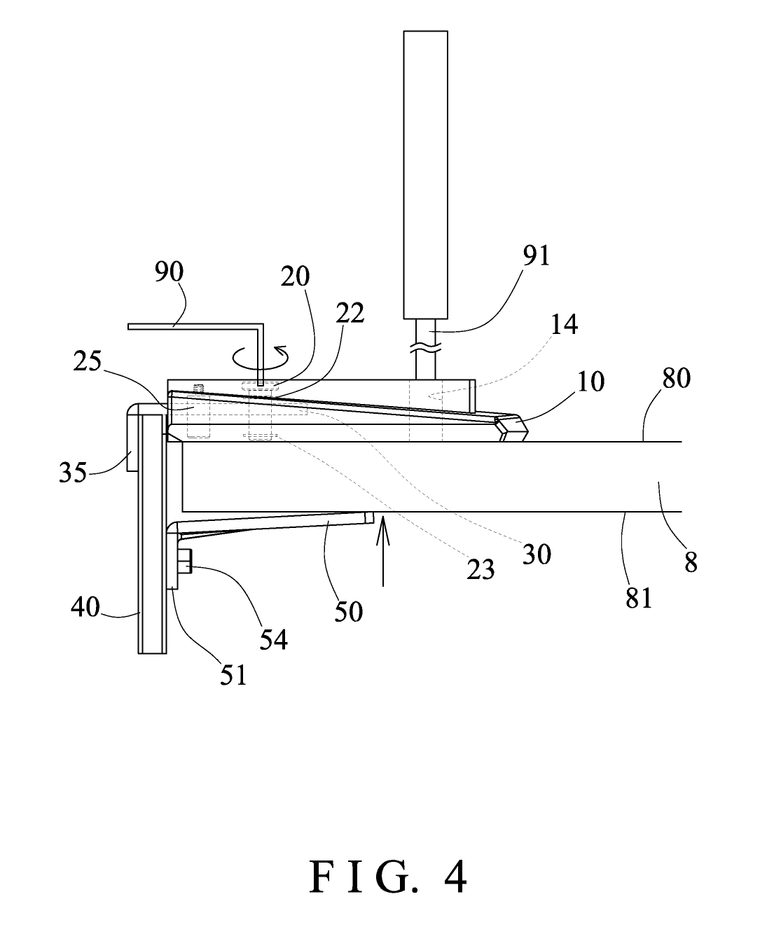

Referring to the drawings, and initially to FIGS. 1-3, a screw clamp in accordance with the present invention comprises a housing or receptacle or block or turret or seat or carrier or support plate or member 10 arranged to be engaged onto and supported on the upper surface 80 of the table plate 8 (FIG. 4), the carrier member 10 includes a chamber or compartment 11 formed therein and having a non-circular cross section and opened downwardly and rearwardly, and includes a through hole 12 formed therein (FIG. 1) and communicating with the compartment 11 of the carrier member 10 for slidably or pivotally or rotatably receiving or engaging with a fastener or bolt or screw 20, and includes a screw hole 13 formed therein (FIG. 1) and also communicating with the compartment 11 of the carrier member 10 for threading or engaging with an anchoring peg or key or member 25.

For example, the guiding member 25 is extended or received or engaged in the compartment 11 of the carrier member 10 and includes a cylindrical or tubular structure having a circular cross section, and includes a threaded section or segment 26 for threading or engaging with the screw hole 13 of the carrier member 10 and for attaching or mounting or securing or positioning the guiding member 25 to the carrier member 10. The screw 20 includes one or more (such as two) engaging notches or grooves or recesses or depressions 21 formed therein (FIG. 1) for threading or engaging with stops or clamping or retaining or anchoring rings or members 22, 23 for anchoring or retaining or positioning the screw 20 to the carrier member 10 and for preventing the screw 20 from being disengaged or separated from the carrier member 10, in which the retaining members 22, 23 are disengaged or separated or spaced from each other.

A clamping device 3 includes a base plate or sliding member or follower 30 slidably received or engaged in the compartment 11 of the carrier member 10 and having a non-circular cross section or outer peripheral structure or configuration or contour similar to that of the compartment 11 of the carrier member 10 for being guided and limited to slide up and down along or relative to the compartment 11 of the carrier member 10 and for preventing the follower 30 from being pivoted or rotated relative to the carrier member 10, the follower 30 further includes an orifice 31 formed therein and having an inner diameter equal to or slightly greater than that of the guiding member 25 for slidably receiving or engaging with the guiding member 25 and for further guiding and limiting the follower 30 to slide up and down along or relative to the compartment 11 of the carrier member 10.

The follower 30 further includes a screw hole 32 formed therein (FIG. 1) and aligned with the through hole 12 of the carrier member 10 for threading or engaging with the screw 20 and for allowing the follower 30 to be actuated or operated to slide or move up and down along or relative to the compartment 11 of the carrier member 10 when the screw 20 is selectively rotated or driven by the screw driver or wrench or other driver tools 90 (FIG. 4), and thus for guiding and moving the follower 30 to slide or move up and down relative to the upper surface 80 of the table plate 8 (FIG. 4). The retaining members 22, 23 are arranged to be disposed or located above and below the follower 30 respectively for contacting or engaging with the upper portion or surface 33 or the lower or bottom portion or surface 34 of the follower 30 respectively and for limiting the follower 30 to slide or move relative to the screw 20 and for preventing the follower 30 from being disengaged or separated from the screw 20.

The follower 30 further includes an anchoring or hanger or coupling plate or extension 35 extended downwardly therefrom and perpendicular to the follower 30 and disposed or located outside the compartment 11 of the carrier member 10, and includes one or more (such as two) holes or apertures 36 formed therein (FIG. 1) for receiving or engaging with screws or fasteners 37 and for attaching or mounting or securing or coupling a guide plate or member 40 to the follower 30. For example, the guide member 40 includes one or more (such as two) screw holes 41 formed therein (FIG. 1) for threading or engaging with the fasteners 37 and for solidly and stably attaching or mounting or securing the guide member 40 to the coupling extension 35 of the follower 30.

The guide member 40 includes a longitudinal channel or slot or groove or passage 42 formed therein (FIG. 1) such as formed in the rear portion of the guide member 40, and faced or directed rearwardly from the guide member 40 and formed or defined between two side columns 43 and a middle or intermediate platform 44, and includes a groove or track or slot or channel 45 formed in each of the columns 43, and the columns 43 each include a substantially C-shaped cross section having a rear wall or panel 46, and a front wall or panel 47 which is parallel to the rear panel 46 but shorter than the rear panel 46, the screw holes 41 are formed in the rear panels 46 respectively, and the columns 43 each include a recess or depression or notch 48 formed in the front panel 47 (FIG. 1) for engaging with the fastener 37 and for further solidly and stably attaching or mounting or securing the guide member 40 to the coupling extension 35 of the follower 30.

An anchoring board 50 includes an end extension or protrusion or plate 51 having one or more (such as two) spaced flaps or ears 52 slidably received or engaged in the channels 45 of the columns 43 respectively for guiding and limiting the anchoring board 50 to slide up and down along or relative to the guide member 40, and the anchoring board 50 is substantially perpendicular to the guide member 40 and disposed below the follower 30 and movable or adjustable up and down and toward or away from the follower 30 for selectively contacting or engaging with the bottom surface 81 of the table plate 8 (FIG. 4). The anchoring board 50 includes an orifice 53 formed in the end plate 51 for slidably receiving or engaging with another screw or bolt or fastener 54, and the guide member 40 includes a longitudinal channel or groove or passage or slot 49 formed in the platform 44 (FIG. 1) and communicating with the passage 42 of the guide member 40 for slidably receiving or engaging with the fastener 54.

The sliding engagement of the fastener 54 in the longitudinal slot 49 of the platform 44 of the guide member 40 may further guide and limit the anchoring board 50 to slide and move relative to the guide member 40 and may prevent the anchoring board 50 from being disengaged or separated from the guide member 40, and the fastener 54 is allowed to be extended or engaged into the passage 42 of the guide member 40 for threading or engaging with a lock nut or anchoring or retaining or positioning or locking member 55. For example, the locking member 55 includes a screw hole 56 formed therein (FIG. 1) for threading or engaging with the fastener 54 and for allowing the anchoring board 50 to be adjustably and stably attached or mounted or secured to the guide member 40, and includes one or more (such as two) pegs or protrusions or keys 57, 58 extended therefrom and slidably received or engaged in the longitudinal slot 49 of the platform 44 of the guide member 40 for preventing the locking member 55 from pivoting or rotating relative to the guide member 40.

In operation, as shown in FIG. 4, the anchoring board 50 may be adjusted and secured to the guide member 40 at the required or selected position or location before the follower 30 and the guide member 40 and the anchoring board 50 of the clamping device 3 are attached or mounted or engaged onto the table plate 8, and the screw 20 may then be rotated or driven by the screw driver or wrench or driver tool 90 in order to force the follower 30 to slide or move up and down relative to the upper surface 80 of the table plate 8 and the carrier member 10 and thus to force the anchoring board 50 to selectively contact or engage with the bottom surface 81 of the table plate 8, and thus to solidly and stably attach or mount or secure the carrier member 10 to the table plate 8 with the driver tool 90 that is located above the table plate 8; i.e., the driver tool 90 may be easily rotated or driven or actuated or operated by the user. The carrier member 10 includes an aperture or orifice or opening or attachment mechanism 14 provided therein for attaching or mounting an object or apparatus or facility 91 to the carrier member 10.

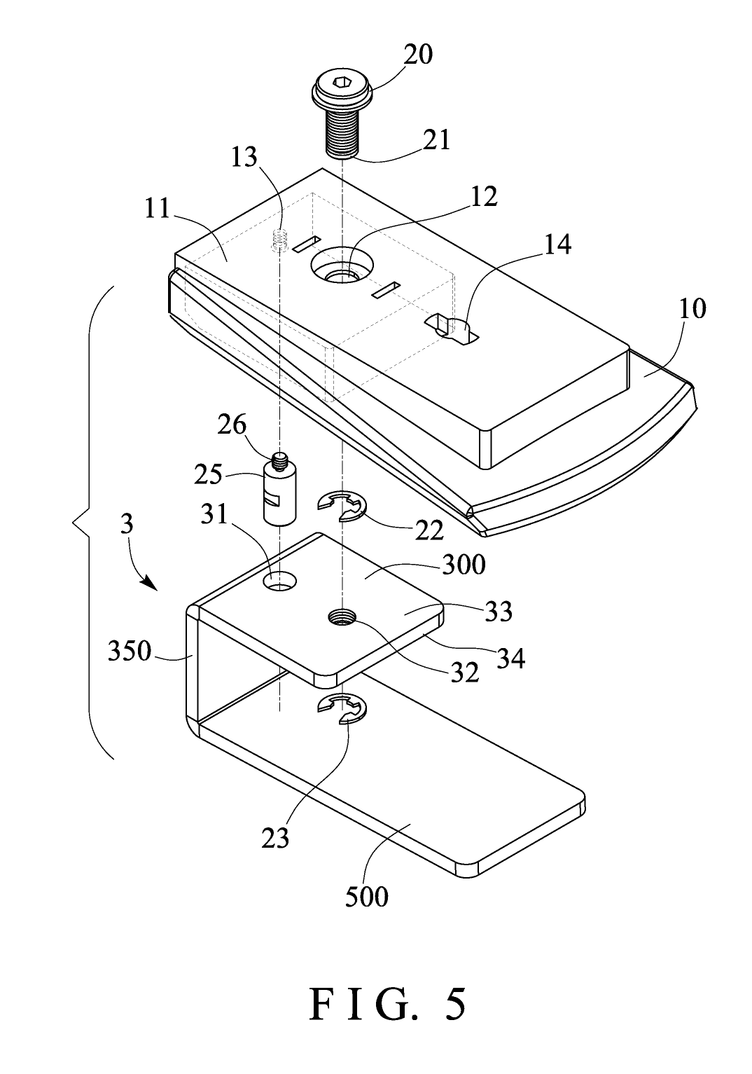

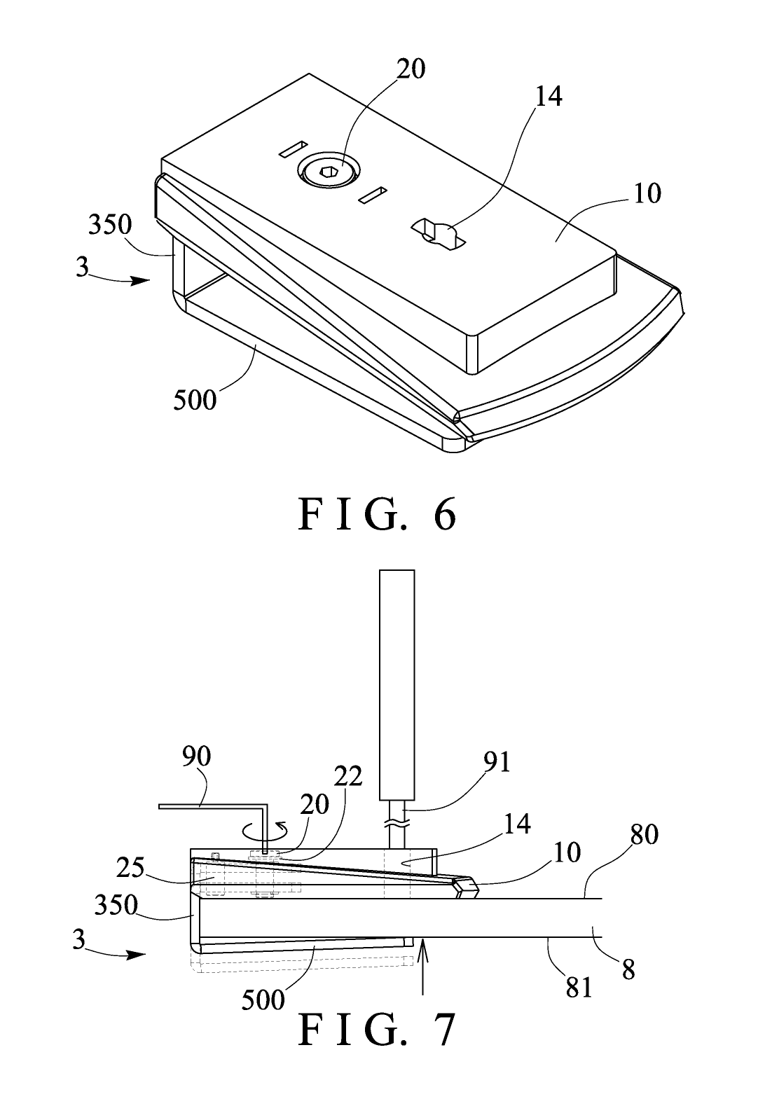

Alternatively, as shown in FIGS. 5-7, the anchoring board 500 of the clamping device 3 may be solidly and stably secured to the coupling extension 350 of the follower 300, or formed integral with the coupling extension 350 of the follower 300 and moved in concert with the coupling extension 350 of the follower 300, and the follower 300 and the anchoring board 500 of the clamping device 3 may be attached or mounted or engaged onto the table plate 8, and the anchoring board 500 of the clamping device 3 may be forced to move and to contact or engage with the bottom surface 81 of the table plate 8, and thus to solidly and stably attach or mount or secure the carrier member 10 to the table plate 8 with the driver tool 90 that is located above the table plate 8; i.e., the driver tool 90 may be easily rotated or driven or actuated or operated by the user.

Accordingly, the screw clamp may be easily actuated or operated by the user, and includes an anchoring board attachable to a carrier member for allowing the carrier member to be easily and quickly engaged through a tiny space beside an edge portion of a table plate and to be easily and quickly attached and mounted to the table plate.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screw clamp for attaching to a table plate, comprising:
a carrier member to be supported on the table plate, said carrier member including a compartment formed therein, and including a through hole formed in said carrier member and communicating with said compartment of said carrier member, and including an attachment mechanism for attaching a facility,
a clamping device including a follower slidably received and engaged in said compartment of said carrier member, and including an anchoring board provided below said follower for engaging with a bottom surface of the table plate, said follower including a screw hole formed therein and aligned with said through hole of said carrier member, and
a screw engaged through said through hole of said carrier member and engaged with said screw hole of said follower for moving said follower up and down relative to said carrier member when said screw is rotated relative to said carrier member.

2. The screw clamp as claimed in claim 1, wherein said follower includes an orifice formed therein, and a guiding member is attached to said carrier member and slidably received and engaged in said orifice of said follower for guiding and limiting said follower to slide up and down relative to said carrier member.

3. The screw clamp as claimed in claim 2, wherein said carrier member includes a screw hole formed therein and communicating with said compartment of said carrier member, and said guiding member includes a threaded segment for engaging with said screw hole of said carrier member.

4. The screw clamp as claimed in claim 1, wherein said carrier member includes a retaining member attached to said screw and located below said follower for limiting said follower to move relative to said screw and for preventing said follower from being disengaged from said screw.

5. The screw clamp as claimed in claim 1, wherein said carrier member includes a retaining member attached to said screw and located above said follower for limiting said follower to move relative to said screw.

6. The screw clamp as claimed in claim 1, wherein said compartment of said carrier member includes a non-circular cross section and opened downwardly and rearwardly, and said follower includes a non-circular cross section for being guided and limited to slide up and down relative to said compartment of said carrier member and for preventing said follower from being rotated relative to said carrier member.

7. The screw clamp as claimed in claim 1, wherein said clamping device includes a guide member attached to said follower, and said anchoring board is slidably attached to said guide member.

8. The screw clamp as claimed in claim 7, wherein said follower includes an extension extended downwardly therefrom and perpendicular to said follower and located outside said compartment of said carrier member for attaching said guide member.

9. The screw clamp as claimed in claim 7, wherein said guide member includes two side columns, and a channel formed in each of said columns, said anchoring board includes two spaced ears slidably received and engaged in said channels of said columns respectively for guiding and limiting said anchoring board to slide up and down relative to said guide member.

10. The screw clamp as claimed in claim 9, wherein said columns each include a C-shaped cross section having a rear panel and a front panel which is parallel to said rear panel and shorter than said rear panel.

11. The screw clamp as claimed in claim 10, wherein said clamping device includes two fasteners engaged through said rear panels of said columns and engaged with said front panels of said columns.

12. The screw clamp as claimed in claim 11, wherein said columns each include a notch formed in said front panel for engaging with said fastener.

13. The screw clamp as claimed in claim 7, wherein said guide member includes a platform, and includes a longitudinal slot formed in said platform, and a fastener engaged through said anchoring board and engaged through said slot of said platform.

14. The screw clamp as claimed in claim 13, wherein said guide member includes a passage formed therein and defined by said platform, and a locking member is slidably received and engaged in said passage of said guide member and includes a screw hole for engaging with said fastener.

15. The screw clamp as claimed in claim 14, wherein said locking member includes at least one key extended therefrom and slidably engaged in said longitudinal slot of said platform for preventing said locking member from being rotated relative to said guide member.
